(19) United States
(12) Patent Application Publication
(10) Pub. No.: US 2008/0228384 A1
(43) Pub. Date: Sep. 18, 2008

(54) Navigational system for a personal mobility device

(76) Inventors: Clinton W. Erickson, Russiaville, IN (US); Richard A. Ripple, Westfield, IN (US); Brian J. Denta, Kokomo, IN (US)

Correspondence Address: DELPHI TECHNOLOGIES, INC., M/C 480-410-202, PO BOX 5052, TROY, MI, 48007, US

(21) Appl. No.: 11/725,043

(22) Filed: Mar. 17, 2007

(51) Int. Cl. G01C 21/20

(52) U.S. Cl. 701/201

(57) ABSTRACT

A transportation system and a method of transporting a handicapped individual are disclosed. The transportation system includes a navigational apparatus having a location sensor coupled to a personal mobility device. The location sensor detects signals emitted from a plurality of beacons disposed throughout the building. The signals include information, which permits the navigational assembly to calculate the location of the personal mobility device within the building. The navigational system then guides the personal mobility device along a pre-determined travel route to the desired location within the building, re-calculating the travel route as necessary to avoid obstacles encountered along the way.

### BACKGROUND OF THE INVENTION

1. Field of the Invention

The subject invention relates to a transportation system and a method of transporting a handicapped individual to a desired location within a building.

2. Description of the Prior Art

Electrically powered personal mobility devices, i.e., wheelchairs, are widely used by handicapped individuals with cognitive, perceptual, or motor impairments that limit the mobility of the handicapped individual. A shortcoming of these devices is that they can be very difficult to control and maneuver in confined areas, such as residences, offices, commercial locations, or entertainment venues. This shortcoming is further complicated when the handicapped individual has limited or impaired use of their limbs, as the personal mobility devices are typically controlled by a joystick type input device. There are other known methods capable of controlling the personal mobility device, such as sip/blow devices, but control of the personal mobility device is still difficult in confined areas. Accordingly, various attempts to aid in navigation of the personal mobility device have been designed and are in use today.

U.S. Pat. No. 6,842,692 issued to Fehr et al. discloses a computer controlled navigational system for an electrically powered personal mobility device. The navigational system includes a filter-based estimator with an interface operable on the computer. The navigational system further includes dual-cameras, proximity sensors, microphones, and rotation sensors for the wheels, mounted to the personal mobility device and coupled to the computer. The dual cameras visually detect markers placed on walls of a room or building, to help locate the personal mobility device within the room or building. The other sensors are utilized to detect obstacles in the path of the personal mobility device. In use, the personal mobility device must be “walked” through the marked location along a desired path, thereby “teaching” the desired path to the computer, which stores the desired path for future reference. The handicapped individual may later recall the path and have the computer maneuver the personal mobility device along the path without any interaction by the handicapped individual. If an obstacle is detected, the navigational system stops the personal mobility device, or returns to the starting location along the path. The navigational system disclosed in the '692 patent operates on line of sight between the markers and the cameras mounted on the personal mobility device. Accordingly, it is essential that the markers not be blocked and that the markers be placed in all rooms in unobstructed view along the desired path.

### SUMMARY OF THE INVENTION AND ADVANTAGES

The subject invention provides a transportation system for transporting a handicapped individual to a desired location within a building. The transportation system comprises a personal mobility device. A navigational apparatus is coupled to the personal mobility device, and guides the personal mobility device along a travel route to the desired location. A plurality of beacons are disposed throughout the building, with each of the plurality of beacons emitting a signal. A location sensor is coupled to the personal mobility device and in communication with the navigational apparatus. The location sensor receives the signals from the plurality of beacons and sends the signals to the navigational apparatus. The navigational apparatus continuously calculates the location of the personal mobility device within the building from the signals received from the plurality of beacons.

The subject invention also provides a method of transporting a handicapped individual with the personal mobility device having the navigational apparatus to the desired location within the building, the building having the plurality of beacons. The method comprises the steps of emitting the signal from each of the plurality of beacons; receiving the signals from the plurality of beacons into the navigational apparatus; calculating the location of the personal mobility device within the building from the signals received; storing a desired travel route in the navigational apparatus; selecting the travel route to the desired location within the building; and moving the personal mobility device along the travel route to transport the individual to the desired location.

Accordingly, the subject invention provides a navigational system having a location sensor that receives signals emitted from a plurality of beacons to locate the personal mobility device within the building. The location sensor on the personal mobility device receives the emitted signal regardless of whether or not the beacons are in the line of sight of the location sensor. Because the beacons do not have to be positioned to be in the line of sight of the location sensor, the transportation system may utilize fewer, more discretely placed beacons throughout the building. Accordingly, a more accurate, versatile, and useful navigational system is provided for the personal mobility device.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a personal mobility device;

FIG. 2 is a schematic view of a transportation system;

FIG. 3 is a perspective view of a beacon for the navigational system;

FIG. 4 is a schematic view of the transportation system showing the personal mobility device along a traveled path;

FIG. 5 is a schematic view of the transportation system showing the traveled path filtered for storage into a memory of the navigational system;

FIG. 6 is a schematic view of the transportation system showing a downloaded travel route transmitted from the building to the personal mobility device;

FIG. 7 is a schematic view of the transportation system showing the personal mobility device avoiding an obstacle; and

FIG. 8 is a schematic view of a navigational system for the personal mobility device.

### DETAILED DESCRIPTION OF THE INVENTION

Referring to the Figures, wherein like numerals indicate corresponding parts throughout the several views, a transportation system is shown generally at 20.

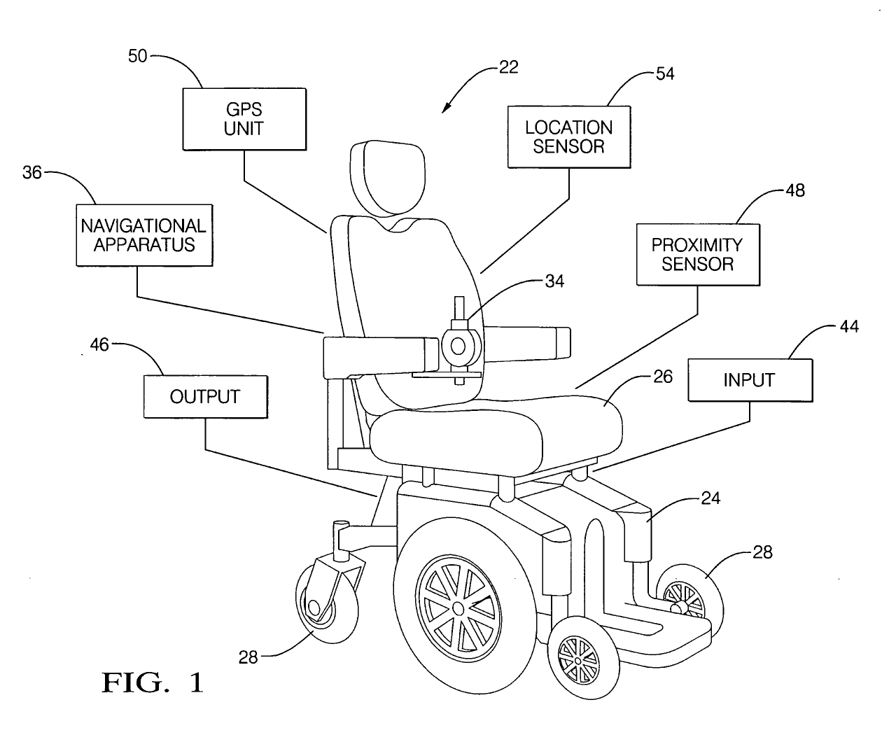

The transportation system 20 transports a handicapped individual to a desired location within a building, and comprises a personal mobility device 22. Referring to FIG. 1, the personal mobility device 22 is preferably an electric wheelchair but may also be some other device, such as a personal scooter or the like. The personal mobility device 22 includes a frame 24, a seat 26 supported on the frame 24, and a plurality of wheels 28 rotatably mounted to the frame 24. A motor (not shown), typically an electric motor, is coupled to at least one of the wheels 28 to drive the personal mobility device 22. A steering mechanism (not shown) is coupled to at least one of the wheels 28 for steering the personal mobility device 22. The steering mechanism may rotate one wheel 28 about a vertical axis to steer the personal mobility device 22, or may control a rotational speed of two parallel drive wheels 28, i.e., driving the parallel drive wheels 28 at different rotational speeds relative to each other, to effectuate the steering of the personal mobility device 22. The personal mobility device 22 further includes a control mechanism 34 for operating the motor and the steering mechanism to control the speed and direction of the personal mobility device 22. It should be understood that there are many different configurations or types of control mechanisms 34 capable of being utilized in conjunction with the personal mobility device 22.

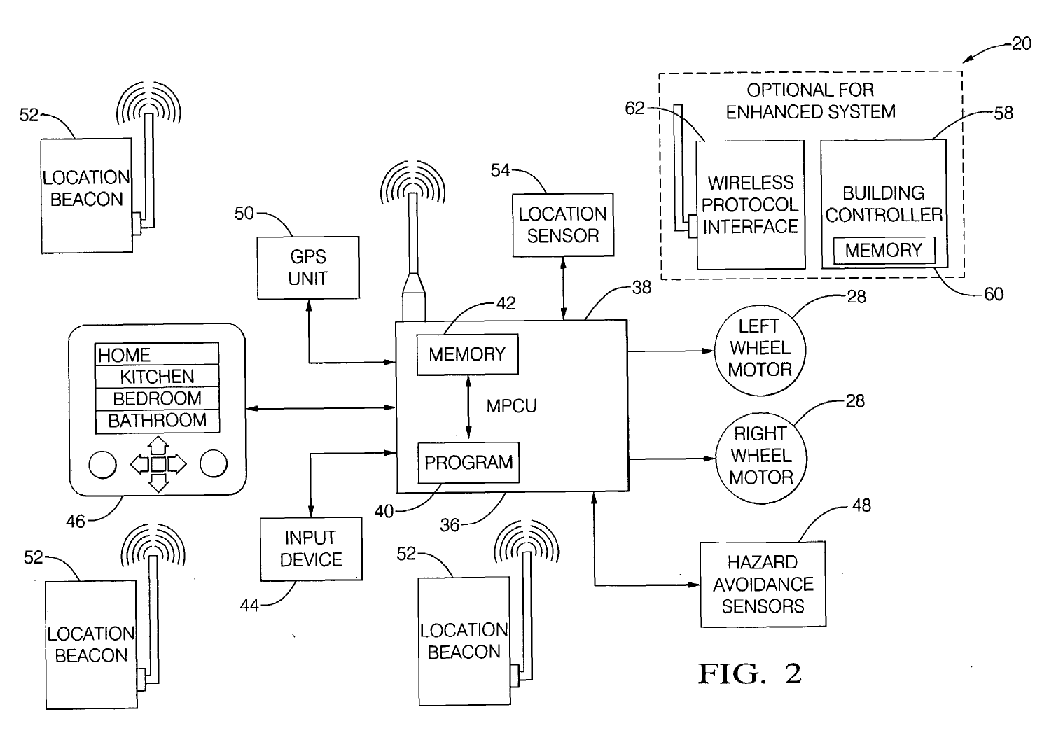

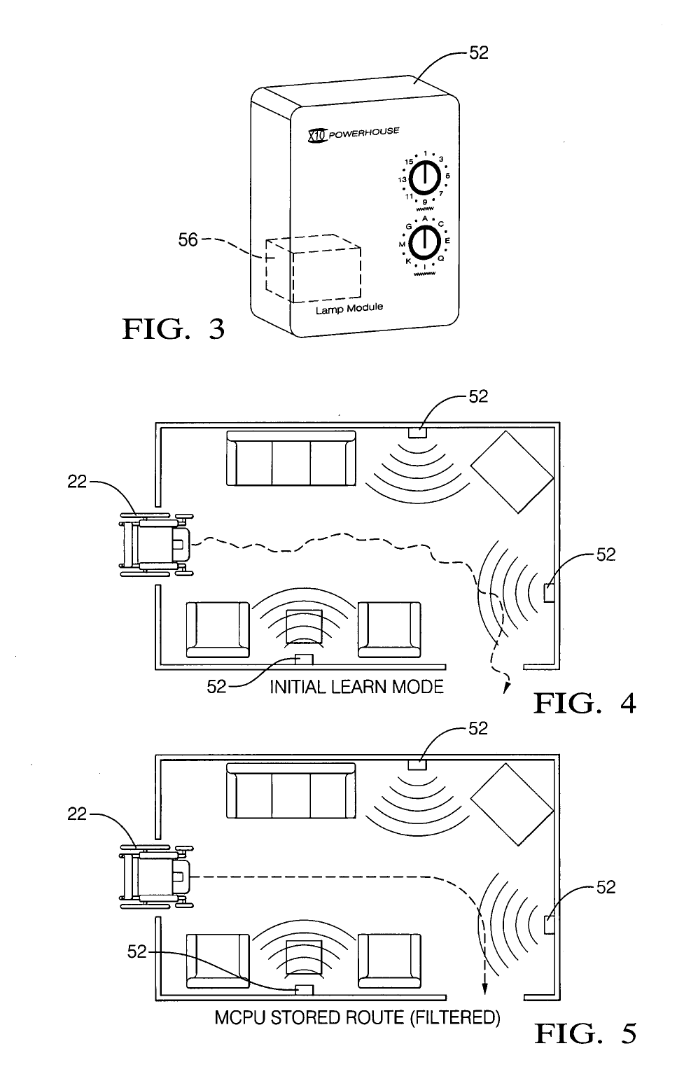

Referring to FIGS. 2 and 3, a navigational apparatus 36 is coupled to the personal mobility device 22, and guides the personal mobility device 22 along a selected travel route to the desired location within the building. The navigational apparatus 36 includes a computer 38 mounted to the personal mobility device 22. A program 40 is operable by the computer 38 for controlling the different aspects and functions of the navigational apparatus 36. The computer 38 may include a laptop computer configured for disposition on the personal mobility device 22, or may include some other configuration of computer mounted in a storage area of the personal mobility device 22. The computer 38 includes a memory 42 for storing information. Specifically, the memory 42 of the computer 38 stores a list of pre-determined travel routes, a building layout, or some other information. The memory 42 is accessed by the program 40 for use by the navigational apparatus 36.

The travel route defines the pre-determined path the personal mobility device 22 follows to transport the handicapped individual to the desired location within the building. It should be understood that the desired location may be the same for some travel routes and different for other travel routes, all within the same building. It should also be understood that travel routes for different buildings may also be stored in the memory 42 of the computer 38 as well. Each travel route stored in the memory 42 of the computer 38 includes a start location from which the travel route begins. The navigational apparatus 36 includes an algorithm for adjusting the travel route to compensate for the personal mobility device 22 not being located at the exact start location. As shown in FIGS. 4 through 7, the travel route includes directions for the navigational apparatus 36 to follow to direct the personal mobility device 22 around corners, hallways, through doorways, around permanent obstructions, etc., directing the personal mobility device 22 to the desired location. For example, the travel route may direct the personal mobility device 22 along a path from the entrance of an office building to a workspace of the handicapped individual, or from the workspace of the handicapped individual to an office copy room, restroom, etc. The transportation system 20 may be utilized in any building, public or private, such as an office building, an airport, a museum, etc.

Referring back to FIG. 2, an input 44 is included for inputting commands into the navigational apparatus 36. The input 44 may include an input 44 chosen from a group comprising a joystick input, a keyboard input, a sip/blow input, and a track balls input. An output 46 is also included for communicating information to the handicapped individual. The output 46 includes one of a group comprising an LCD display, and a vacuum fluorescent display. Accordingly, the handicapped individual interacts with the navigational apparatus 36 through the input 44 and the output 46. Specifically, the output 46 displays the list of the pre-determined travel routes for the handicapped individual to choose from. The handicapped individual utilizes the input 44 to select the travel route from the list of pre-determined travel routes stored in the memory 42 of the computer 38 and displayed on the output 46. It should be understood that the input 44 and the output 46 may include other devices then specifically enumerated herein.

The navigational apparatus 36 includes a proximity sensor 48 coupled to the personal mobility device 22. The proximity sensor 48 may include at least one proximity sensor 48 chosen from a group comprising an ultrasonic sensor, an infra-red sensor, and a video sensor. The proximity sensor 48 senses obstacles within the travel route of the personal mobility device 22 so that the program 40 may re-calculate the travel route around the obstacle. The program 40 includes an algorithm capable of processing the information sensed regarding the obstacle and devising an alternative course around the obstacle. Likewise, and as discussed above, the navigational apparatus 36 is capable, given all necessary information, of revising the travel route to compensate for the personal mobility device 22 beginning at a location different from the start point. It should be understood that the proximity sensor 48 may include some other type of sensor capable of detecting objects in the travel path of the personal mobility device 22 not specifically enumerated herein.

A global positioning satellite unit 50 is coupled to the personal mobility device 22 and is in communication with the navigational apparatus 36. The global positioning satellite unit 50 determines the location of the personal mobility device 22 so that the navigational apparatus 36 may be utilized to direct the handicapped individual or otherwise guide the personal mobility device 22 to the building. The global positioning satellite unit 50 operates as is well known in the art to locate an object from signals received from satellites.

Referring also to FIGS. 3 through 7, a plurality of beacons 52 is disposed throughout the building, and are in wireless communication with a location sensor 54 described below. Each of the plurality of beacons 52 emits a signal with the navigational apparatus 36 continuously calculating the position of the personal mobility device 22 within the building from the signals. The signal from the plurality of beacons 52 may include a radio frequency signal, an infra-red signal, or some other signal capable of containing information therein as described above. In order to enable the navigational apparatus 36 to calculate the location of the personal mobility device 22, each of the signals includes different information encoded within each of the signals related to a location of each of the plurality of beacons 52 emitting each of the signals.

The information encoded, or sent with the signal, may include the room the individual beacon 52 emitting the specific signal is located in, the coordinates of the beacon 52 with in the room, or the building the beacon 52 is located in. This information, when compared to the layout of the building or to the selected travel route, allows the navigational apparatus 36 to calculate the current location of the personal mobility device 22. It should be understood that other information not specifically enumerated herein may be included with the signal.

Referring back to FIG. 2, at least one location sensor 54 is coupled to the personal mobility device 22 and is in communication with the navigational apparatus 36. The location sensor 54 receives the signals form the beacons 52 and sends the signals to the navigational apparatus 36. The location sensor 54 may include an infra-red sensor, a radio-frequency sensor, or some other sensor capable of sensing the signal emitted from the beacons 52 and the information encoded therein. It should be understood that the location sensor 54 is chosen to sense the specific type of signal emitted from the beacon 52. For example, if the beacon 52 emits an infra-red signal, the location sensor 54 will include an infra-red sensor. It should also be understood that the personal mobility device 22 may include multiple sensors for detecting signals having different formats, i.e., an infra-red sensor for sensing an infra-red signal and a radio-frequency sensor for sensing a radio frequency signal. In this way, the navigational apparatus 36 may function properly at several different buildings, using beacons 52 emitting different signal formats.

The plurality of beacons 52 is electrically powered, and include a battery backup module 56 to provide power to the beacon 52 in case of a power outage within the building where the beacon 52 is located. The beacons 52 may be conveniently placed out of sight, and still function properly as the beacons 52 emit their respective signals in a non-directional manner, i.e., the beacons 52 do not operate on line of sight technology. Therefore, the location sensors 54 need only be able to sense the signal, not be in the line of sight of the beacon 52.

The transportation system 20 further comprises a building controller 58 having a controller memory 60 for storing information related to the building. An interface 62 interconnects the navigational apparatus 36 and the building controller 58 for transmitting the information related to the building between the navigational apparatus 36 and the building controller 58. The interface 62 may include a wireless network providing bi-directional communication between the navigational system 20 and the building controller 58. It should be understood that the interface 62 may include some other device capable of bi-directional communication between the navigational apparatus 36 and the building controller 58 not specifically enumerated or described herein.

The information stored in the controller memory 60 of the building controller 58 related to the building may include pre-determined travel routes throughout the building; a layout of the building including all doors, elevators, rooms, hallways, etc.; a location of each of the beacons 52, emergency contact information, or some other information related to the building. All of the information stored within in the building controller 58 may be communicated to the handicapped individual if necessary, through the output 46, by way of the interface 62 interconnecting the building controller 58 and the navigational apparatus 36.

The subject invention also provides a method of transporting the handicapped individual. The method utilizes the personal mobility device 22 described above to transport the individual to the desired location within the building. The building having the beacons 52, the building controller 58, and the interfaces 62 as also described above. The method comprises the steps of emitting the signal from each of the plurality of beacons 52. The signal may be an infra-red signal, a radio-frequency signal, or some other format of signal capable of transmitting information therewith. The information contained in the signal may include a plurality of travel routes for the building, the layout of the building, or some other piece of in formation as described above.

The signals, from the plurality of beacons 52, are received into the navigational apparatus 36. The location sensors 54 sense, or receive, the signals from the beacons 52, and then send the signal to the navigational apparatus 36. The current location of the personal mobility device 22 within the building is then calculated from the signals received. The program 40 on the computer 38 of the navigational apparatus 36 uses the information contained in the signal to locate the personal mobility device 22 along the travel route. For example, if the information included in the signal includes information related to the room the beacon 52 is located in and a direction or bearing between the personal mobility device 22 and the beacon 52, the navigational apparatus 36 may triangulate the position of the personal mobility device 22 by comparing the information of two separate beacons 52 to the travel route, or by overlaying the information from the two separate beacons 52 on the layout of the building to get the position of the personal mobility device 22 within the building. It should be understood that the program 40 may employ other methods of calculating the location of the personal mobility device 22 using the same or other information related to the location of the beacons 52 within the building and sent to the navigational apparatus 36 through the signal emitted by the beacons 52.

Alternatively, the step of locating the personal mobility device 22 may further include utilizing the global positioning satellite unit 50 located on the personal mobility device 22 to locate the personal mobility device 22 within the building or outside the building. Having the location of the personal mobility device 22 outside the building, along with a location for the building, permits the navigational apparatus 36 to guide the personal mobility device 22 to the building. At which point, the navigational apparatus 36 may utilize the location obtained from the global positioning satellite unit 50, or from the signals emitted by the beacons 52 to locate the personal mobility device 22 within the building so that the personal mobility device 22 may move along a selected travel route.

The navigational apparatus 36 may also include a compass, or some other directional sensor for sensing the direction of the personal mobility device 22. Additionally, the navigational apparatus 36 may also include a wheel 28 speed sensor, or some other sensor for sensing the speed of the personal mobility device 22. When so equipped, the method may further comprise the step of sensing the direction of travel of the personal mobility device 22, and sensing the distance traveled by the personal mobility device 22. The sensed distance and direction traveled may be used by the navigational assembly to locate the position of the personal mobility device 22 within the building by the process of “dead reckoning” as is well known.

The method further includes the step of storing the travel route into the memory 42 of the navigational apparatus 36. It should be understood that the travel route may include a plurality of travel routes, and the step of storing the travel route includes storing the plurality of travel routes. The travel route is the desired path for the personal mobility device 22 to follow to the desired location within the building or described above. Once stored in the memory 42 of the navigational apparatus 36, the handicapped individual selects the desired travel route to the desired location within the building. The travel route is selected by the handicapped individual by use of the input 44 as described above.

Once the desired travel path is selected, the personal mobility device 22 is then moved along the travel route to transport the individual to the desired location. The navigational apparatus 36 is in communication with the control mechanism 34 of the personal mobility device 22, thereby guiding the personal mobility device 22 along the travel route by engaging the motor and the steering mechanism to maintain the personal mobility device 22 on the travel route.

Referring to FIGS. 4 and 5, the method further comprises the step of learning the travel route to the desired location. The step of learning the travel route includes manually moving the personal mobility device 22 to the desired location, with the navigational apparatus 36 recording the path traveled. Once the path traveled is stored in the memory 42 of the computer 38, a filter algorithm smoothes the traveled path to define the travel route. The learned travel route is then stored in the memory 42 of the computer 38 for future selection by the handicapped individual.

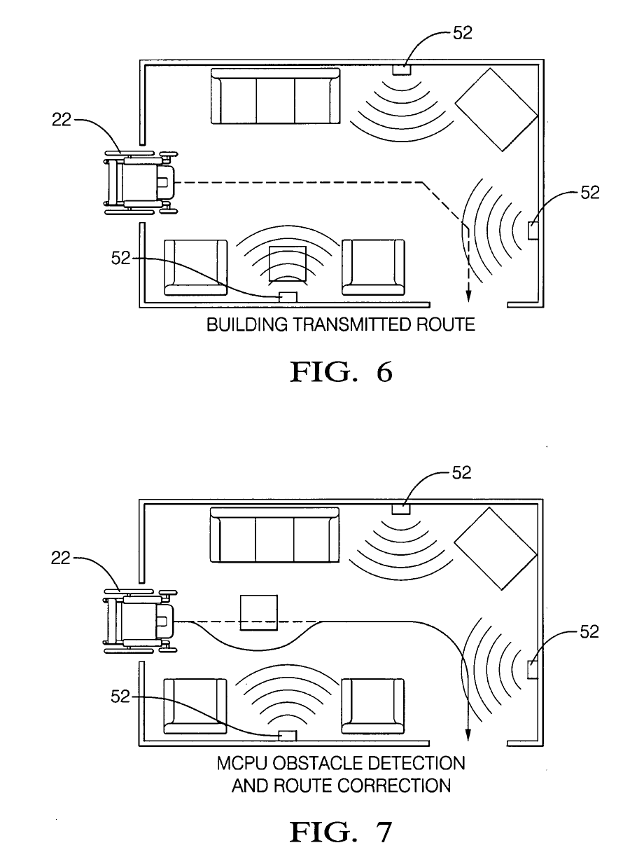

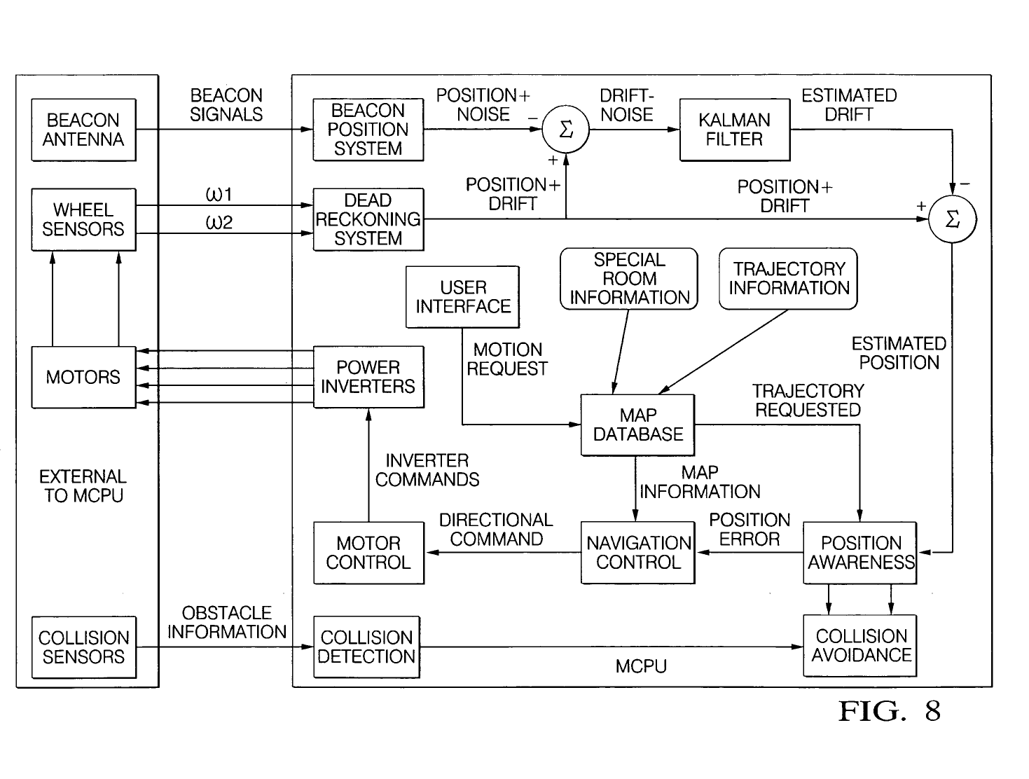

The method further comprises the step of communicating information related to the building between the navigational apparatus 36 and the building controller 58. The step of communicating information related to the building may include transmitting a layout of the building to the navigational apparatus 36. Similarly, and as represented in FIG. 6, the step of communicating information related to the building may include transmitting a plurality of travel routes to the navigational apparatus 36. It should be understood that other information may be communicated between the building controller 58 and the navigational apparatus 36 to assist in moving or guiding the personal mobility device 22 along the travel route and through the building.

The method further comprises the step of communicating a position of the personal mobility device 22 to the building controller 58. If the building controller 58 knows the dynamic position of the personal mobility device 22 as the personal mobility device 22 moves along the travel route, then the building controller 58 may assist the handicapped individual along the travel route by opening doors, signaling elevators, turning on lights, or some other form of assistance. Accordingly, the step of communicating information related to the building may include steps of opening doors within the building as the personal mobility device 22 approaches, and signaling elevators as the personal mobility device 22 approaches.

The method further comprises the step of displaying a list of all travel routes stored in the navigational apparatus 36. As described above, all of the stored travel routes are displayed on the output 46, so that the handicapped individual may select the desired travel route.

Because obstacles may be temporarily placed in the way of the travel route, which would interfere with the movement of the personal mobility device 22 along the travel route, the method further comprises the step of sensing an obstacle interfering with the travel route. Referring to FIG. 7, the proximity sensor 48 or sensors are utilized to sense the obstacle as described above. Once an obstacle is sensed, the method further comprises the step of calculating a revised travel route in response to sensing an obstacle to avoid the obstacle. An algorithm within the program 40 uses the information from the proximity sensors 48, along with the layout of the building and the current location of the personal mobility device 22 to re-calculate the revised travel route around the obstacle.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A method of transporting a handicapped individual with a personal mobility device having a navigational apparatus to a desired location within a building having a plurality of beacons, said method comprising the steps of:
emitting a signal from each of the plurality of beacons;
receiving the signals from the plurality of beacons into the navigational apparatus;
calculating the current location of the personal mobility device within the building from the signals received;
storing a desired travel route in the navigational apparatus;
selecting the travel route from the navigational apparatus to the desired location within the building;
moving the personal mobility device along the travel route to transport the individual to the desired location.

2. A method as set forth in claim 1 further comprising the step of learning the travel route to the desired location.

3. A method as set forth in claim 1 wherein the building includes a building controller and the method further comprises the step of communicating information related to the building between the navigational apparatus and the building controller.

4. A method as set forth in claim 3 wherein the step of communicating information related to the building includes transmitting a layout of the building to the navigational apparatus.

5. A method as set forth in claim 3 wherein the step of communicating information related to the building includes transmitting a plurality of travel routes to the navigational apparatus.

6. A method as set forth in claim 5 further comprising the step of storing the plurality of travel routes in the navigational apparatus.

7. A method as set forth in claim 6 further comprising the step of displaying a list of all travel routes stored in the navigational apparatus.

8. A method as set forth in claim 7 further comprising the step of selecting the travel route from the list of travel routes stored in the navigational apparatus.

9. A method as set forth in claim 3 further comprising the step of communicating a position of the personal mobility device to the building controller.

10. A method as set forth in claim 9 wherein the step of communicating information related to the building includes opening doors within the building as the personal mobility device approaches.

11. A method as set forth in claim 9 wherein the step of communicating information related to the building includes signaling elevators as the personal mobility device approaches.

12. A method as set forth in claim 1 further comprising the step of sensing an obstacle interfering with the travel route.

13. A method as set forth in claim 12 further comprising the step of calculating a revised travel route in response to sensing an obstacle to avoid the obstacle.

14. A method as set forth in claim 1 wherein said navigational system includes a global positioning satellite unit and said step of locating the personal mobility device is further defined as utilizing the global positioning satellite unit to locate the personal mobility device within the building.

15. A method as set forth in claim 14 further comprising sensing the direction of travel of the personal mobility device.

16. A method as set forth in claim 15 further comprising sensing the distance traveled by the personal mobility device.

17. A transportation system for transporting a handicapped individual to a desired location within a building, said transportation system comprising:
a personal mobility device;
a navigational apparatus coupled to said personal mobility device for guiding said personal mobility device along a travel route to the desired location;
a plurality of beacons for disposition throughout the building with each of said plurality of beacons emitting a signal;
a location sensor coupled to said personal mobility device and in communication with said navigational apparatus for receiving said signals from said plurality of beacons and sending said signals to said navigational apparatus for said navigational apparatus to continuously calculate the location of said personal mobility device within the building from said signals.

18. A system as set forth in claim 17 wherein each of said signals includes different information encoded within each of said signals related to a location of each of said plurality of beacons emitting each of said signals.

19. A system as set forth in claim 18 wherein said signal from said plurality of beacons includes a radio frequency signal.

20. A system as set forth in claim 18 wherein said signal from said plurality of beacons includes an infra-red signal.

21. A system as set forth in claim 17 further comprising a building controller having a memory for storing information related to the building.

22. A system as set forth in claim 21 further comprising an interface interconnecting said navigational apparatus and said building controller for transmitting the information related to the building between said navigational apparatus and said building controller.

23. A system as set forth in claim 22 wherein said interface includes a wireless network providing bi-directional communication between said navigational system and said building controller.

24. A system as set forth in claim 17 wherein said navigational apparatus includes an input for inputting commands into said navigational apparatus.

25. A system as set forth in claim 24 wherein said input includes one of a group comprising a joystick input, a keyboard input, a sip/blow input, and a track balls input.

26. A system as set forth in claim 17 wherein said navigational apparatus includes an output for communicating information to the handicapped individual.

27. A system as set forth in claim 26 wherein said output includes one of a group comprising an LCD display, and a vacuum fluorescent display.

28. A system as set forth in claim 17 wherein each of said plurality of beacons includes a battery backup module.

29. A system as set forth in claim 17 wherein said navigational apparatus includes a proximity sensor coupled to said personal mobility device for detecting obstacles obstructing the travel route.

30. A system as set forth in claim 29 wherein said proximity sensor includes at least one chosen from a group comprising an ultrasonic sensor, an infra-red sensor, and a video sensor.

31. A system as set forth in claim 17 wherein said navigational apparatus includes a computer mounted to said personal mobility device.

32. A system as set forth in claim 31 wherein said navigational apparatus includes a program operable by said computer.

33. A system as set forth in claim 17 wherein said navigational apparatus includes a global positioning satellite unit for determining the location of said personal mobility device.
